(19) United States
(12) Patent Application Publication
(10) Pub. No.: US 2026/0300254 A1
(43) Pub. Date: Oct. 1, 2026

(54) DATABASE AGNOSTIC WATCHES USING WAL-BASED ARCHITECTURE

(71) Applicant: Confluent Inc., Mountain View, CA (US)

(72) Inventors: Arjun Satish, Los Gatos, CA (US); Abhishek Arora, Mountain View, CA (US); Yuanchao Yu, Shawnee, KS (US); Jonathan Paul Rosenberg, Redmond, WA (US)

(21) Appl. No.: 19/096,092

(22) Filed: Mar. 31, 2025

(51) Int. Cl. G06F 16/23

(52) U.S. Cl. CPC G06F 16/2358

(57) ABSTRACT

Systems and methods provide a database-agnostic watch service using a write-ahead log (WAL)-based architecture. The system (e.g., a metadata service platform) receives a watch API call from a watch client to subscribe to receiving change notifications, whereby the watch API call includes filtering criteria. Subsequently, a mutation request is received from a client (e.g., a CRUDL client), that comprises a request to change, update, or delete an object in a database. The system writes the mutation request to a request log and then executes the mutation request. Next, the system generates a response message that includes the mutation request and an execution status. This response message is appended to the response log. Based on the response log, a watch server receives change events and generates and transmits the change notifications to the watch client based on the filtering criteria applied to the change events.

### TECHNICAL FIELD

The subject matter disclosed herein generally relates to monitoring for change events within a database. Specifically, the present disclosure addresses systems and methods that provides a watch service on any type of databases using a write-ahead log (WAL)-based architecture.

### BACKGROUND

Cloud-computing systems have grown in popularity as a method of providing computer implemented resources. In the realm of cloud computing and distributed systems, traditional database architectures face significant challenges in providing timely and reliable notifications of changes to stored data. As businesses increasingly rely on real-time data processing and event-driven architectures, the need for efficient mechanisms to monitor and react to database changes is vital. A challenge with traditional database systems is their reliance on change data capture (CDC) streams to track modifications. While CDC streams are designed to capture changes in the database, they often operate on a best-effort basis. This can result in unpredictable latencies and potential data loss. This latency is problematic for applications that require immediate notifications, such as monitoring systems and automated response mechanisms.

Moreover, existing solutions often depend on complex infrastructures to process and dispatch change events. This approach not only adds latency but also increases operational overhead due to the need for maintaining and operating these components. Additionally, integrating CDC streams with various databases can be challenging, as the process may not provide the ordering guarantees or scalability required for efficient data processing. These limitations highlight the need for a more robust and efficient mechanism to monitor and react to database changes in real-time, ensuring timely and reliable notifications across diverse database environments.

### BRIEF DESCRIPTION OF THE DRAWINGS

Various ones of the appended drawings merely illustrate examples of the present disclosure and should not be considered as limiting its scope.

FIG. 1 is a high-level diagram illustrating an example write-ahead log (WAL)-based architecture suitable for providing a database agnostic watch service, according to example embodiments.

FIG. 2 is a diagram illustrating a logical flow between components associated with the WAL-based architecture, according to example embodiments.

FIG. 3 is a diagram illustrating a physical flow between components associated with the WAL-based architecture, according to example embodiments.

FIG. 4 is a diagram illustrating static sharding with the WAL-based architecture, according to example embodiments.

FIG. 5 is a diagram illustrating a Kafka-based watch flow in the WAL-based architecture, according to example embodiments.

FIG. 6 is a high-level diagram illustrating the WAL-based architecture that includes a reconciler, according to example embodiments.

FIG. 7 is a flowchart of a method for providing the watch service using the WAL-based architecture, according to example embodiments.

FIG. 8 is a flowchart of a method for generating and providing a notification by a watch server, according to example embodiments.

FIG. 9 is a block diagram illustrating components of a machine, according to some examples, able to read instructions from a machine-storage medium and perform any one or more of the methodologies discussed herein.

### DETAILED DESCRIPTION

The description that follows describes systems, methods, techniques, instruction sequences, and computing machine program products that illustrate examples of the present subject matter. In the following description, for purposes of explanation, numerous specific details are set forth in order to provide an understanding of various examples of the present subject matter. It will be evident, however, to those skilled in the art, that examples of the present subject matter may be practiced without some or other of these specific details. Examples merely typify possible variations. Unless explicitly stated otherwise, structures (e.g., structural components) are optional and may be combined or subdivided, and operations (e.g., in a procedure, algorithm, or other function) may vary in sequence or be combined or subdivided.

Example embodiments provide an architecture that enables a watch application protocol interface (API) to be implemented on any database by leveraging a write-ahead log (WAL) to ensure a correct order of changes and scalability. This architecture decouples event capture and dissemination from the database, allowing for a more reliable and efficient notification system. By utilizing a WAL, the example embodiments preserve the order of changes in a scalable manner, supporting multiple databases (e.g., DynamoDB, Cosmos, and Spanner). Example embodiments also address the limitations of traditional change data capture (CDC) streams, which often lack strong ordering guarantees and have high latencies. Additionally, the example embodiments supports dynamic sharding and fault tolerance, ensuring that watch events are delivered to clients even in the event of failures. This approach not only enhances the reliability and performance of watch notifications but also provides a cloud-agnostic solution that can be integrated with various backend systems and/or databases.

As a result, example embodiments provide a technical solution to the technical problem of providing accurate and timely watch notifications. In particular, the technical solution writes each mutation request to a request log. The request log responds with a log sequence number (LSN). The mutation request is then executed on a database. A response message that includes the mutation request, the LSN, and a status of the execution is appended to a response log. Data from the response log is then used by a watch server to detect change events. The watch server can then filter on the change events to determine change events relevant to a watch client. The filtered change events can then be provided in a watch notification to the watch client. In some embodiments, the watch notification comprises a watch stream.

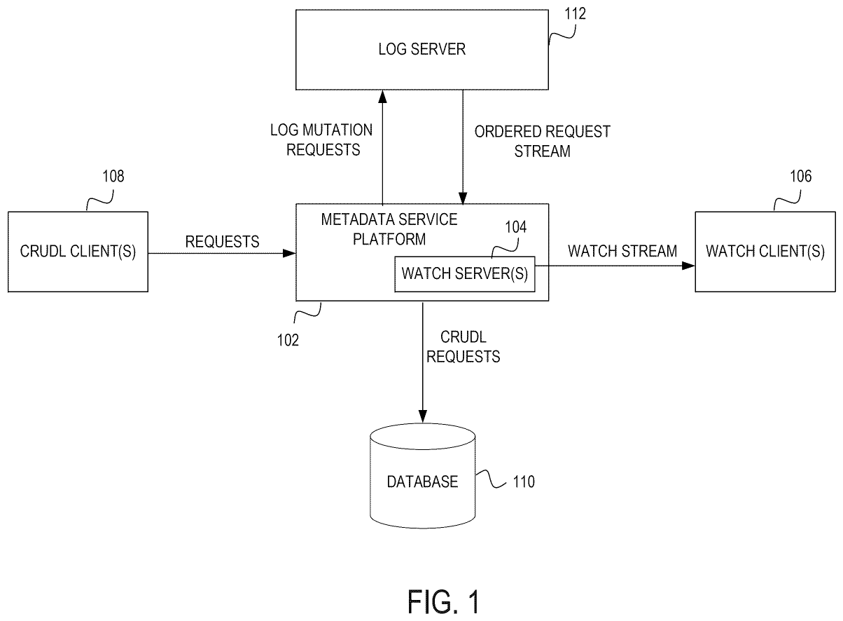

FIG. 1 is a high-level diagram illustrating an example write-ahead log (WAL)-based architecture suitable for providing a database-agnostic watch service, according to example embodiments. A metadata service platform 102 serves as a centralized storage layer and source of truth for all metadata across a real-time streaming platform. In example embodiments, the metadata service platform 102 is configured to work with real-time data streaming and seamless integration and data transfer between a client system and cloud storage (e.g., cloud computing platform). In one example, a real-time streaming platform that comprises the metadata service platform 102 is Confluent Cloud™.

In example embodiments, the metadata service platform 102 comprises one or more watch servers 104. The watch server 104 provides a watch application programming interface (API) that delivers a stream of changes (e.g., a watch stream) to watch client(s) 106 (also referred to herein as a “notification” or “watch notification”). Each watch client 106 subscribes to a watch service to receive notifications of the changes in a database (e.g., database 110) that is relevant to the watch client 106. Thus, each watch client can provide specific filters for change events. The watch server 104 will be discussed in more detail below.

Initially, CRUDL (create, read, update, delete, and list) clients 108 send requests to the metadata service platform 102. The CRUDL clients 108 can comprise client applications or services which are using services of the metadata service platform 102. The requests can include “mutation requests” that create, update, and/or delete objects in a database 110. In some embodiments, the database 110 is a cloud service provider (CSP) database that stores data that is subject to CRUDL operations. It is noted that any type of database 110 can be used since example embodiments are database agnostic. The database 110 interacts with the metadata service platform 102 to apply changes and maintain a current state of the data. In example embodiments, the metadata service platform 102 is a stateless service whereby every request is mapped to an operation in the database 110.

The WAL-architecture of FIG. 1 includes a log server 112 that hosts a WAL where every mutation request to the metadata service platform 102 is logged. The log server 112 maintains two primary logs: a request log (also referred to herein as “Q log”) and a response log (also referred to herein as “S log”). The log server 112 provides an append(entry) method on each log, which appends new entries on the log and a tail(offset) which allow a start of tailing of the log starting from a given offset or from a current position when the offset is not provided. The WAL is then leveraged to serve the watch clients 106, as will be discussed in more detail below.

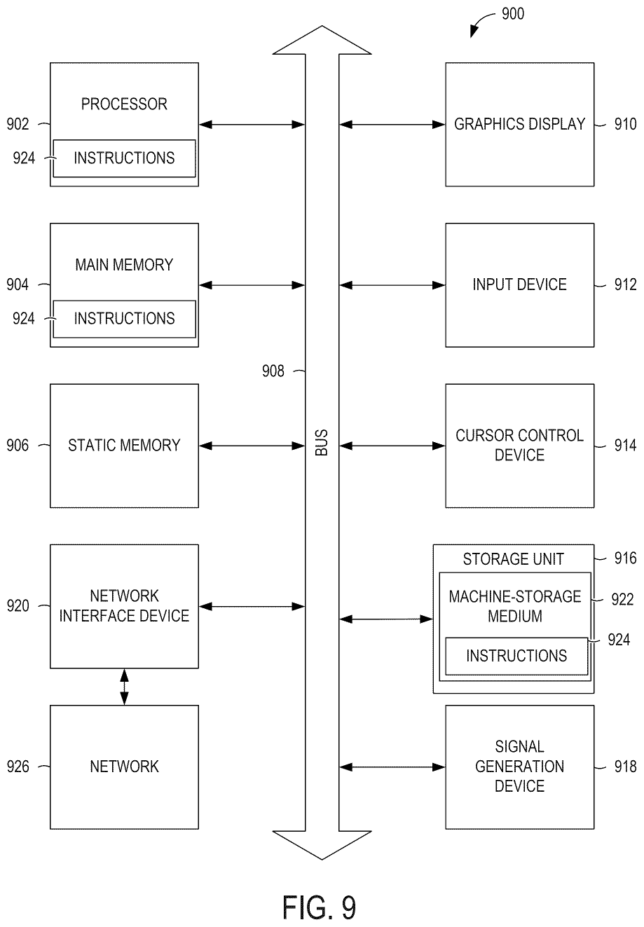

Any of the clients, platforms, servers, or databases (collectively referred to as “components”) shown in, or associated with, FIG. 1 may be, include, or otherwise be implemented in a special-purpose (e.g., specialized or otherwise non-generic) computer that can be modified (e.g., configured or programmed by software, such as one or more software components of an application, operating system, firmware, middleware, or other program) to perform one or more of the functions described herein for that system or machine. For example, a special-purpose computer system able to implement any one or more of the methodologies described herein is discussed below with respect to FIG. 9, and such a special-purpose computer is a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

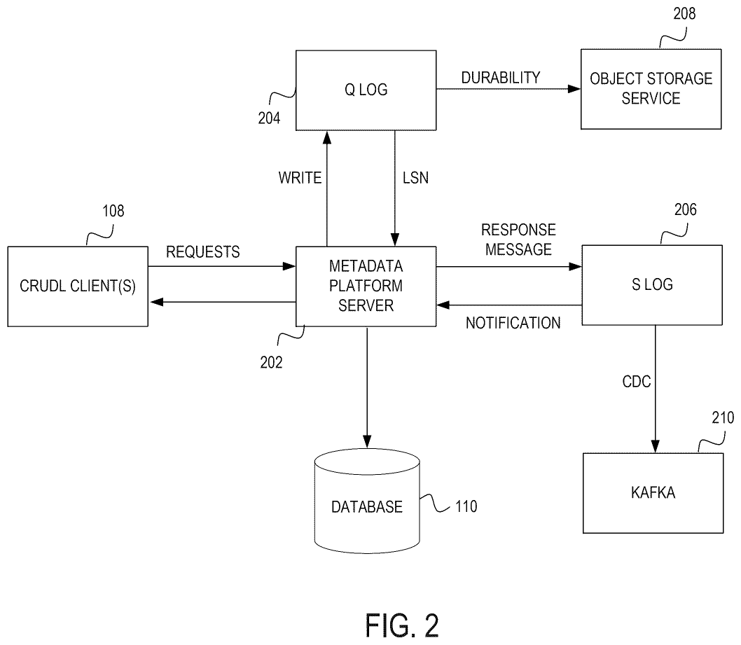

FIG. 2 is a diagram illustrating a logical flow between components associated with the WAL-based architecture, according to example embodiments. The logical flow involves a single metadata platform server 202 talking to a single request log (Q log 204) and a single response log (S log 206) within a log server (e.g., the log server 112). When the metadata platform server 202 starts up, it starts to tail both the Q log 204 and S log 206 from their current position. In example embodiments, a thread is tailing each of the Q log 204 and the S log 206.

Initially, the metadata platform server 202 receives one or more requests from the CRUDL clients 108. In one embodiment, each request is received via a remote procedure call (RPC) API (e.g., gRPC). In some cases, the request is a mutation request that indicates a modification to an object that is or will be stored to the database 110. In other cases, the request is a read request (e.g., get or list) and the Q log 204 and S log 206 are not involved. Instead, the read request is executed on the database 110 directly.

For mutation requests, instead of making a write to the database 110 as is traditionally done, the metadata platform server 202 (e.g., a thread within the metadata platform server 202) writes the mutation request to the request log (Q log 204). In response, the Q log 204 provides a log sequence number (LSN). In example embodiments, the LSN corresponds to an entry in the Q log 204. In example embodiments, a thread (or goroutine) tailing the Q log 204 receives a callback with the LSN. The metadata platform server 202 then waits for a response from the S log 206 corresponding to the LSN.

In example embodiments, the Q log 04 is buffered on the log server 112 and can be published to an object storage service 208. In one example, the object storage service 208 is the Simple Storage Service (S3). In order to not keep a lot of data in the Q log 204, the data in the Q log 204 is periodically flushed into the object storage service 208 and the Q log 204 cleaned up. For example, the Q log 204 can be flushed every few minutes (e.g., five minutes), while the cleanup can occur every few hours. Thus, what the Q log 204 maintains in memory is lightweight and supports very efficient reads. Additionally, the object storage service 208 provides long-term durability and can be used for disaster recovery.

After the write to the Q log 204, another thread (e.g., the thread tailing the Q log 204) can execute the mutation request and mark the object in the database 110 with the LSN number. The execution of the mutation request results in a change to an object in the database 110 (e.g., creation of an object, modification of an object, deletion of an object). The marking can occur in the object directly or in a metadata row for that logical partition. In example embodiments, the marking helps to fence out-of-order writes. For example, if the metadata platform server 202 processes a mutation request, applies it to the database 110, and restarts, the metadata platform server 202 may attempt to apply the change again. The marking in the database will prevent this from occurring.

A response message is then generated (e.g., by the metadata platform server 202) and appended to the S log 206. The response message can comprise the original mutation request, the LSN, and/or a status of the execution of the mutation request. For example, the thread that executed the mutation request can indicate that the mutation request was completed and provide a result of the execution.

The metadata platform server 202 that is waiting for the response from the S log 206 corresponding to the LSN is now notified (e.g., receives a notification). This notification serves as an acknowledgment that the mutation request has been processed and logged in the response log. Once notified, the metadata platform server 220 (e.g., a thread within the metadata platform server 202) can respond to the CRUDL client 108 with an indication that the mutation request is now completed.

The S log 206 comprises all the changes that were made to the database 110 successfully. The S log 206 can be filtered to remove any failure responses. In some embodiments, the filtered results from the S log 206 are used to generate a change data capture (CDC) stream that feeds into Kafka 210. The results can then be dispatched to watch clients (e.g., watch clients 106) from Kafka 210, as will be discussed in more detail below. In other embodiments, the S log 206 can be used by a watch server (e.g., watch server 104) directly to obtain watch events or filtered changes.

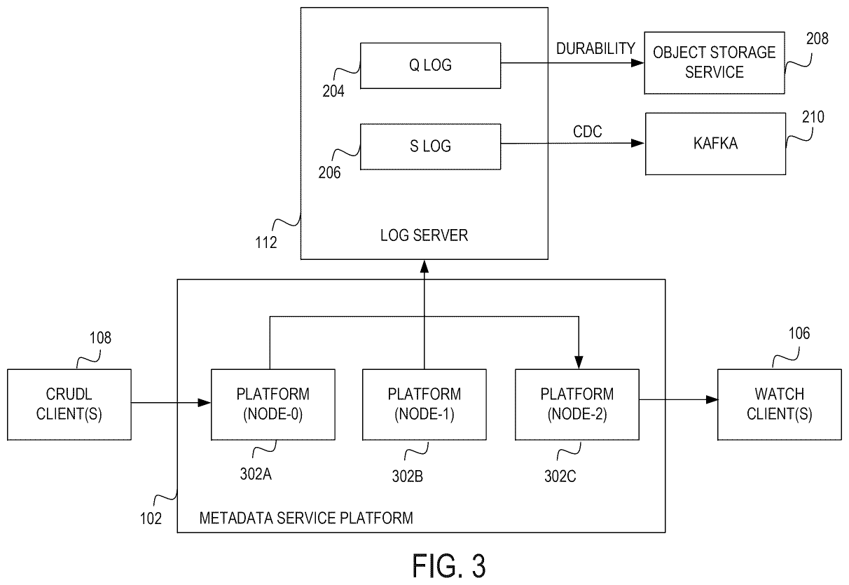

FIG. 3 is a diagram illustrating a physical flow between components associated with the WAL-based architecture, according to example embodiments. Actual deployment of the logical flow illustrated in FIG. 2 can have multiple nodes 302 in a cluster of the metadata service platform 102. The CRUDL clients 108 send requests to the metadata service platform 102 and can essentially be in communication with any of the nodes 302 for execution of the requests.

In example embodiments, the nodes 302 represent instances of the metadata service platform 102 running within a Kubernetes cluster. Each node 302 can comprise one or more containers that execute necessary components of the metadata service platform 102. The nodes 302 can handle client requests, process database changes, and interact with the logs 204 and 206 as well as with the watch clients 106. The use of multiple nodes 302 allows the metadata service platform 102 to scale horizontally, providing redundancy and load balancing.

Once one of the nodes 302 receives a mutation request, the mutation request is logged with the Q log 204 in the log server 112. In one embodiment, the node 302 writes their node identifier (node-ID) along with other fields in the Q log 204. A listening thread on each node 302 will only process entries which have their node-ID in it. In one embodiment, the node-ID is a universally unique identifier (UUID), which is unique for every new node.

In cases where a node goes down, a client can retry against a new node, The entries in the Q log 204 that were written by the node that died will simply be ignored by the other nodes and the new node. However, if the entry was applied to the database (e.g., database 110) and the original node went down before it could respond to the CRUDL client 108 and the CRUDL client 108 retries, the nodes 302 will need to rely on optimistic locking to ensure that the nodes 302 are not incorrectly writing twice to the database.

While the physical flow discussed in the embodiment of FIG. 3 is a simple approach, latency may be an issue. Because all the nodes 302 append their requests to a single request log (e.g., Q log 204) and a single response log (e.g., S log 206), each node 302 can see request and response entries for all other nodes in the cluster. This can potentially add a high latency for the flow per API request. As such, an alternative approach can maintain multiple logs—one for each shard so that each node only has to work with the logs pertinent to it.

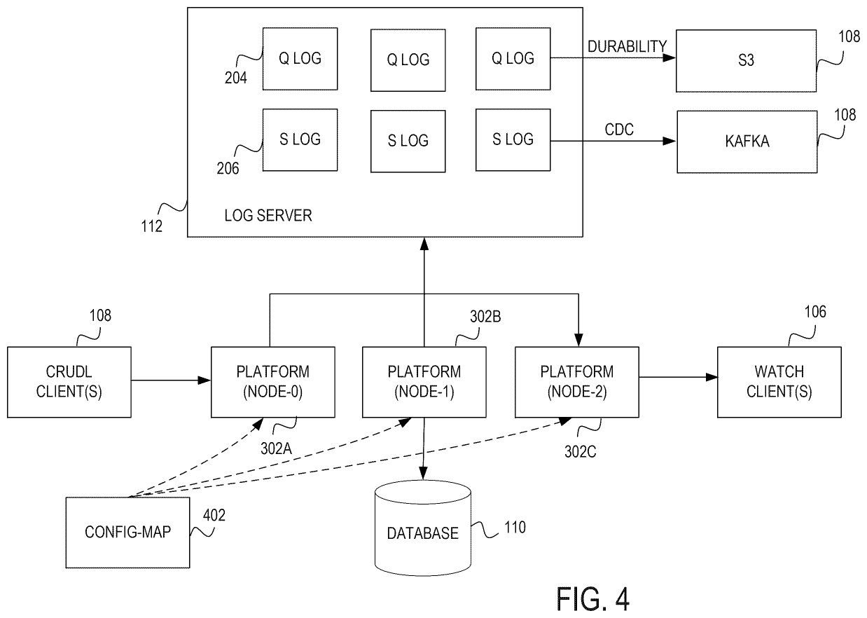

Referring now to FIG. 4, a diagram illustrating static sharding with the WAL-based architecture, according to example embodiments, is shown. In order to allow for sharding, a config-map 402 is introduced into the WAL-based architecture. The config-map 402 is used to statically assign which node executes requests on the database for each shard. This configuration ensures that each node 302 is responsible for handling a particular subset of the data or workload. Thus, each node (node-0 302a, node-1 302b, node-2 302c) is responsible for processing requests and managing logs related to its assigned shard. The Q log 204 and S log 205 are also sharded in a corresponding manner as the nodes. This means that a node will only interact with the Q log 204 and S log 206 pertinent to its shard. By focusing on specific shards, the nodes 302 can reduce latency and improve efficiency, as they only process relevant data and do not need to handle the entire dataset.

In one embodiment, assume there are k shards distributed among n nodes, where k>n. The distribution can be specified using the k8s StatefulSet configuration. Each node's node-ID, which is static for the StatefulSet, can be used to determine which shard each node owns.

In operation, when a node (e.g., pod 302a) receives a mutation request, it first checks which node owns this shard (e.g., via the static configuration it has received). If the node (e.g., node 302a) itself is the owner, then it executes the mutation request. However, if the owner is a different node, the node (e.g., node 302a) forwards to the mutation request to its respective owner (e.g., node 302c). The owner (e.g., node 302c) proceeds to append the mutation request to the Q log 204 and S log 206 that corresponds to the owner (e.g., node 302c). The appending of the mutation request occurs similar to how it was outlined in the logical flow above.

Additionally, each node 302 can periodically write a last sequence number (LSN) for a shard it executed to a special row in the database 110. This allows each node to save its progress as a marker in the database 110 and is helpful for when/if the node is restarted. That is, the node can restart processing requests from this marker. Additionally, the markers in each row that is modified can fence duplicate writes. Overall, such a sequence number commit can help a node catch up to its last position quickly. While this may create duplicate rows in a watch Kafka, they are easy to deduplicate at a consumer end by again using the LSN. For example, the watch server (e.g., watch server 104) can simply drop watch events that are older than what it last processed.

In example embodiments, if a particular node has too much load, a partition re-assignment (e.g., via a script or CLI) can be performed. New nodes can be added and problematic shards for the particular node can be redistributed between these new nodes.

Other shards on other nodes will not be affected. Thus, static sharding allows for horizontal scaling by adding more nodes and redistributing shards as needed. This approach allows for load balancing, as each node handles a portion of the workload and prevents any single node from becoming a bottleneck. Additionally, in the event that a node fails, the static sharding configuration can be adjusted to reassign the affected shard to another node, ensuring continuity and fault tolerance.

In some embodiments, it might be worthwhile to assign a secondary node for every replica. This helps with high availability for every shard. The node that receives a request can then decide to forward the request to the secondary node if the primary node does not respond within a reasonable time or if the primary node is down (e.g., due to reboots or rolls), In various embodiments, the node can be a container, a process, or a pod.

While the embodiment of FIG. 4 discusses the use of static sharding, alternatively, dynamic sharding can be used. Unlike static sharding, where shards are assigned to nodes based on a predefined configuration, dynamic sharding allows for real-time adjustments to shard assignments. Thus, the system can automatically rebalance shards across nodes when new nodes are added, or existing nodes are removed. Dynamic sharding also enables the system to adjust shard assignments based on current workload and resource availability.

This means that as demand fluctuates, the system can redistribute shards to optimize performance and resource utilization. In the event of a node failure, dynamic sharding can quickly reassign affected shards to other nodes, maintaining continuity and minimizing downtime. In some embodiments, dynamic sharding may involve consensus protocols, such as Raft or Paxos, to ensure that shard assignments are consistent across nodes and that changes are made reliably.

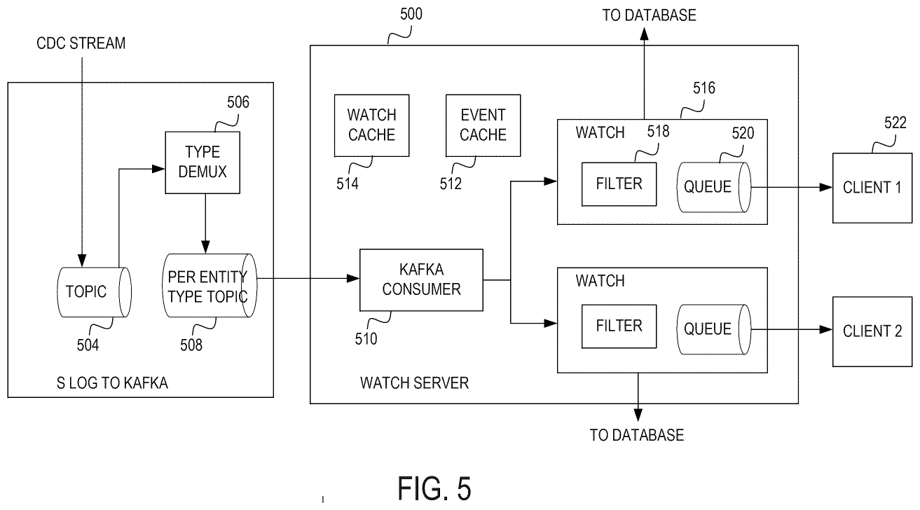

FIG. 5 is a diagram illustrating a Kafka-based watch flow in the WAL-based architecture, according to example embodiments. The embodiment of FIG. 5 focuses on the integration of a change data capture (CDC) stream with Kafka and a watch server 500. Specifically, the CDC stream is transmitted from the S log 206 to Kafka 210. The CDC stream captures changes from the S log 206 including executed create, update, and delete operations.

In example embodiments, the S log 206 is written directed to a topic 504. By writing directly to the topic 504, there is no dependency on Lambdas, which can be an operational hassle). In one embodiment, the topic 504 represents a Kafka topic for all entity types. Thus, the topic 504 can host change events for all entity types.

Next, a type demux 506 consumes from the all-type Kafka topic 504 and writes each entity type to its own topic (e.g., a per-type entity topic 508). Thus, the type demux 506 categorizes change events based on their entity type. The per-type entity topic 508 ensures that events are processed and managed on a per-entity basis, allowing monitoring of changes related to individual entities. In an alternative embodiment, the S log comprises a topic that feeds directly into the type demux 506.

The watch server 500 is the central component responsible for managing client subscriptions and delivering change notifications. The watch server 500 is configured to host watch APIs and serve watch streams. In example embodiments, the watch server 500 processes incoming change events and ensures that watch clients receive updates based on their specific filters. The watch server 500 is completely stateless and horizontally scalable. In order to perform these operations, the watch server 500 comprises a Kafka consumer 510, an event cache 512, a watch cache 514, and a plurality of watches 516.

The Kafka consumer 510 is configured to read events from the per-type entity topic 508 and write the events in order to an event cache 512. In example embodiments, each watch 516 maintains a current offset and has a thread that can pull messages from the event cache 512 from the required offset at its own rate depending on how fast a watch client is consuming.

The watch cache 514 is configured to store watch requests. When new watch request are made, the watch cache 514 is populated with a KV: (entity-type)->(set of watch requests). Thus, the watch cache 514 keeps track of all active watches. In some embodiments, the watch cache 514 can have a mapping of subscribers and what they are subscribing to along with watch filters.

In example embodiments, the event cache 512 comprises a first in first out (FIFO) cache or ring buffer that stores the events in order. In some cases, the event cache 512 can be implemented with ring buffer properties in memory or on a KV store. Thus, if multiple subscriptions match events in the event cache 512, the watch server 500 does not need to go back to Kafka. Instead, the matching events can be consumed from memory (e.g., the event cache 512).

The watches 516 each represents a logical structure that manages client subscriptions. Each watch 516 includes a filter 518 and a queue 520. Upon start up, the watches 516 typically request a snapshot from the database 110. Subsequently, the change events can be processed. The filter 518 is configured to apply client-specific criteria to the incoming change events. Thus, the filter 518 ensures that only events matching the client's interests are processed and queued for delivery. The queue 520 is configured to temporarily hold filtered events before they are sent to the client 522. The queue 520 manages the order and timing of event delivery so that the client 522 receives updates in a consistent and timely manner. A notification can then be generated from the queue and transmitted to the client 522. In some cases, the notification comprises a watch stream.

It is noted that there can be any number of clients 522. Because a simple watch API call is used to manage watch clients within the metadata service platform 102, any number of watch clients can be supported efficiently. For example, the watch API call provides a straightforward interface for watch clients to subscribe to changes in the database and provide filters. This simplicity reduces the complexity involved in integrating with the watch service. Additionally, the watch API can handle a large number of concurrent requests, allowing the metadata service platform 102 to scale as the number of watch clients increases. This scalability can be achieved by replicating the watch server 500 across multiple instances to distribute the load evenly. In some embodiments, the watch server 500 can be a node and/or the node can have all the components of the watch server 500.

In non-Kafka embodiments, the S log 206 can provide the change stream directly to the watch server 500. Instead of a Kafka consumer 510 in the watch server 500, an event consumer can read events from the change stream and write the events in order to the event cache 512. Thus, the S log 206 is the original data source for the watch server 500—be it directly or via Kafka.

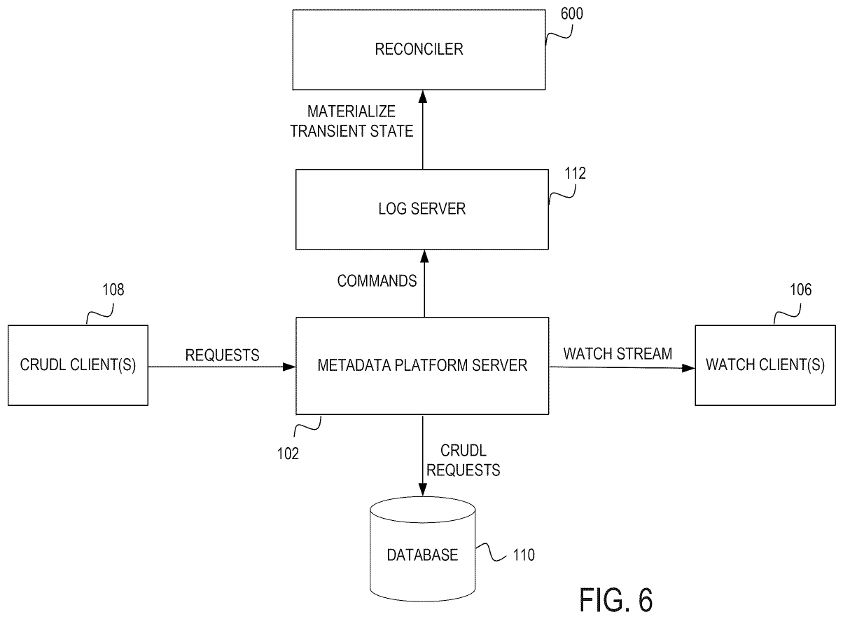

FIG. 6 is a high-level diagram illustrating the WAL-based architecture of FIG. 1 that includes a reconciler 600, according to example embodiments. The WAL-based architecture comprises the metadata platform server 102, the watch client(s) 106, the CRUDL client(s) 108, the database 110, the log server 112, and the reconciler 600. The reconciler 600 is responsible for materializing a transient state based on the logs maintained by the log server 112.

In example embodiments, the reconciler 600 ensures that the changes captured in the logs are accurately reflected in the watch stream delivered to the watch client(s) 106. For example, the reconciler 600 processes the logged commands to ensure that the current state of the database is accurately reflected in the watch stream. By consuming the commands from the logs, the reconciler 600 can verify that all changes have been correctly applied to the database 110 and that the watch stream accurately represents these changes. Additionally, the reconciler 600 can track execution progress of commands logged in the write-ahead logs, ensuring that each command is completed successfully. In some case, the reconciler 600 updates the status of each command, marking them for garbage collection once they are fully processed.

In the event of failures or discrepancies, the reconciler 600 can identify and correct issues by cross-referencing the logs with the current state on the database 110. This capability ensures that any missed or incomplete changes are addressed, providing a reliable watch service even in the face of system disruptions.

In one embodiment, there can be a case where the logs do not capture the state of a failed database operation. In this case, the LSN markers are used to check if the database 110 was actually updated by the original command in the Q log. If the LSN in the DB is below the one in the Q log, that means the command never mutated the object in the database 110. However, if LSN is equal to or larger, then the reconciler 600 will take the latest state of the object and emit it back to the S log (completing that log).

The reconciler 600, itself, uses the LSN in the Q log to track its progress, periodically committing this to the database 110. If there is a restart of the reconciler 600, the reconciler 600 can obtain the LSN from the database 110 and continue operations.

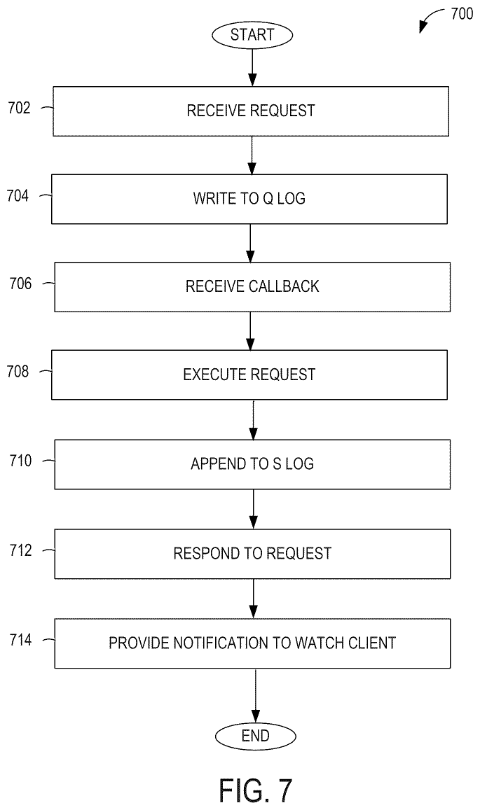

FIG. 7 is a flowchart of a method 700 for providing the watch service using the WAL-based architecture, according to example embodiments. Operations in the method 700 may be performed by the components in the WAL-based architecture described above with respect to FIG. 1-FIG. 6. Accordingly, the method 700 is described by way of example with reference to components in the WAL-based architecture. However, it shall be appreciated that at least some of the operations of the method 700 may be deployed on various other hardware configurations or be performed by similar components. Therefore, the method 700 is not intended to be limited to these components.

In operation 702, a mutation request is received by the metadata service platform 102. The mutation request is received from a CRUDL client 108 and can involve operations such as create, update, or delete data in the database 110.

In operation 704, the metadata service platform 102 (e.g., a thread within the metadata platform server 202 or a node) writes the mutation request to the Q log 204. This operation ensures that the mutation request is logged in a sequential manner and provides a record of the request/operation that can be later referenced if needed.

In operation 706, the metadata service platform 102 (e.g., a thread within the metadata platform server 202 or a node) receives a callback from the Q log 204 that includes an LSN. In example embodiments, the LSN corresponds to an entry in the Q log 204. The callback indicates that the mutation request has been successfully logged.

In operation 708, the mutation request is executed. In example embodiments, a thread (e.g., the thread tailing the Q log 204) can execute the mutation request and mark the LSN number in the database 110. The execution of the mutation request results in a change to an object in the database 110 (e.g., creation of an object, modification of an object, deletion of an object).

In operation 710, the thread or node then appends a result of the execution to the S log 206. In example embodiments, a response message is generated and appended to the S log 206, whereby the response message comprises the original mutation request, the LSN, and/or a status of the execution of the mutation request In operation 712, the metadata service platform 102 provides a response to the mutation request. The response is sent back to the CRUDL client(s) 108 indicating the completion and result of the requested operation (e.g., the mutation request).

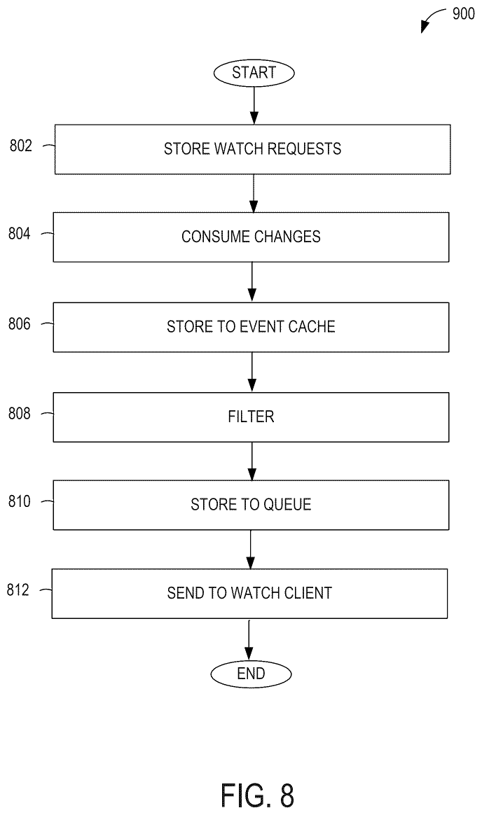

In operation 714, a notification is provided to a watch client. This notification informs the watch client of the changes made to the database 110. Operations for providing the notification will be discussed in more detail in connection with FIG. 8 below.

FIG. 8 is a flowchart of a method 800 (e.g., operation 714) for generating and providing a notification by the watch server, according to example embodiments. Operations in the method 800 may be performed by the components in the WAL-based architecture described above with respect to FIG. 1-FIG. 6. Accordingly, the method 800 is described by way of example with reference to components in the WAL-based architecture. However, it shall be appreciated that at least some of the operations of the method 800 may be deployed on various other hardware configurations or be performed by similar components. Therefore, the method 800 is not intended to be limited to these components.

In operation 802, the watch server (e.g., watch server 104, 500) receives and stores watch requests from watch clients. These requests specify the types of changes the watch clients are interested in and any filters the watch client wants to apply. The watch requests can be stored to the watch cache 514 such that the watch server maintains a mapping of watch clients to their respective watch request.

In operation 804, the watch server consumes change events from a data source. In some embodiments, the data source is the S log 206. In some embodiments, the data source is a Kafka topic. In example embodiments, the consuming comprises reading the events sequentially to ensure a correct order is maintained.

In operation 806, the consumed events are stored to the event cache 512, which acts as a temporary storage area. The event cache 512 allows the watch server to quickly access and process events without repeatedly querying the data sources. Thus, the event cache 512 helps to reduce latency and improve the responsiveness of the watch server.

In operation 808, the watch server filters the events stored in the event cache 512. In example embodiments, the watch server applies the client-specific filters via the filter 518 in each watch 516. The filtering ensures that only relevant changes are processed for each watch client based on their specified interests.

In operation 810, the filtered events are stored in the queue 520, which temporarily holds the filtered events before delivery to the watch client. The queue 520 manages the order and timing of event delivery and can accommodate for variations in client consumption rates.

In operation 812, the watch server sends the queued events to the subscribed watch client as a change notification. In example embodiments, the watch server packages the queued events into a format suitable for client consumption and transmits them over a network. In some cases, the change notification comprises a watch stream.

FIG. 9 illustrates components of a machine 900, according to some example embodiments, that is able to read instructions from a machine-storage medium (e.g., a machine-storage device, a non-transitory machine-storage medium, a computer-storage medium, or any suitable combination thereof) and perform any one or more of the methodologies discussed herein. Specifically, FIG. 9 shows a diagrammatic representation of the machine 900 in the example form of a computer device (e.g., a computer) and within which instructions 924 (e.g., software, a program, an application, an applet, an app, or other executable code) for causing the machine 900 to perform any one or more of the methodologies discussed herein may be executed, in whole or in part.

For example, the instructions 924 may cause the machine 900 to execute some or all of the diagrams and flowcharts of FIG. 7 and FIG. 8. In one embodiment, the instructions 924 can transform the machine 900 into a particular machine (e.g., specially configured machine) programmed to carry out the described and illustrated functions in the manner described.

In alternative embodiments, the machine 900 operates as a standalone device or may be connected (e.g., networked) to other machines. In a networked deployment, the machine 900 may operate in the capacity of a server machine or a client machine in a server-client network environment, or as a peer machine in a peer-to-peer (or distributed) network environment. The machine 900 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 924 (sequentially or otherwise) that specify actions to be taken by that machine. Further, while only a single machine is illustrated, the term “machine” shall also be taken to include a collection of machines that individually or jointly execute the instructions 924 to perform any one or more of the methodologies discussed herein.

The machine 900 includes a processor 902 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 904, and a static memory 906, which are configured to communicate with each other via a bus 908. The processor 902 may contain microcircuits that are configurable, temporarily or permanently, by some or all of the instructions 924 such that the processor 902 is configurable to perform any one or more of the methodologies described herein, in whole or in part. For example, a set of one or more microcircuits of the processor 902 may be configurable to execute one or more components described herein.

The machine 900 may further include a graphics display 910 (e.g., a plasma display panel (PDP), a light emitting diode (LED) display, a liquid crystal display (LCD), a projector, or a cathode ray tube (CRT), or any other display capable of displaying graphics or video). The machine 900 may also include an input device 912 (e.g., a keyboard), a cursor control device 914 (e.g., a mouse, a touchpad, a trackball, a joystick, a motion sensor, or other pointing instrument), a storage unit 916, a signal generation device 918 (e.g., a sound card, an amplifier, a speaker, a headphone jack, or any suitable combination thereof), and a network interface device 920.

The storage unit 916 includes a machine-storage medium 922 (e.g., a tangible machine-storage medium) on which is stored the instructions 924 (e.g., software) embodying any one or more of the methodologies or functions described herein. The instructions 924 may also reside, completely or at least partially, within the main memory 904, within the processor 902 (e.g., within the processor's cache memory), or both, before or during execution thereof by the machine 900. Accordingly, the main memory 904 and the processor 902 may be considered as machine-storage media (e.g., tangible and non-transitory machine-storage media). The instructions 924 may be transmitted or received over a network 926 via the network interface device 920.

In some example embodiments, the machine 900 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the components described herein.

### Executable Instructions and Machine-Storage Medium

The various memories (e.g., 904, 906, and/or memory of the processor(s) 902) and/or storage unit 916 may store one or more sets of instructions and data structures (e.g., software) 924 embodying or utilized by any one or more of the methodologies or functions described herein. These instructions, when executed by processor(s) 902 cause various operations to implement the disclosed embodiments.

As used herein, the terms “machine-storage medium,” “device-storage medium,” “computer-storage medium” (referred to collectively as “machine-storage medium 922”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 922 include non-volatile memory, including by way of example semiconductor memory devices, for example, erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage medium or media, computer-storage medium or media, and device-storage medium or media 922 specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 924 may further be transmitted or received over a communications network 926 using a transmission medium via the network interface device 920 and utilizing any one of a number of well-known transfer protocols (e.g., HTTP). Examples of communication networks 926 include a local area network (LAN), a wide area network (WAN), the Internet, mobile telephone networks, plain old telephone service (POTS) networks, and wireless data networks (e.g., Wi-Fi, LTE, and WiMAX networks). The term “transmission medium” shall be taken to include any intangible medium that is capable of storing, encoding, or carrying instructions 924 for execution by the machine 900, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

In some embodiments, a hardware component may be implemented mechanically, electronically, or any suitable combination thereof. For example, a hardware component may include dedicated circuitry or logic that is permanently configured to perform certain operations. For example, a hardware component may be a special-purpose processor, such as a field programmable gate array (FPGA) or an ASIC. A hardware component may also include programmable logic or circuitry that is temporarily configured by software to perform certain operations. For example, a hardware component may include software encompassed within a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where the hardware component comprises a general-purpose processor configured by software to become a special-purpose processor, the general-purpose processor may be configured as respectively different special-purpose processors (e.g., comprising different hardware components) at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors.

Similarly, the methods described herein may be at least partially processor-implemented, a processor being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented components may be located in a single geographic location (e.g., within a home environment, an office environment, or a server farm). In other example embodiments, the one or more processors or processor-implemented components may be distributed across a number of geographic locations.

### EXAMPLES

Example 1 is a method for providing a database-agnostic watch service using a write-ahead log (WAL)-based architecture. The method comprises receiving, by a metadata service platform, a mutation request from a client, the mutation request comprising a request to change, update, or delete an object in a database; writing, by the metadata service platform, the mutation request to a request log prior to executing the mutation request; executing, by the metadata service platform, the mutation request on the database; responsive to executing the mutation, generating, by the metadata service platform, a response message that includes the mutation request and an execution status; appending the response message to a response log; based on the response log, receiving, by a watch server, change events; and generating and transmitting a change notification to a watch client based on filtering criteria of the watch client applied to the change events.

In example 2, the subject matter of example 1 can optionally include in response to writing the mutation request to the request log, receiving a callback with a log sequence number (LSN) from the request log, the LSN corresponding to an entry in the request log associated with the mutation request.

In example 3, the subject matter of any of examples 1-2 can optionally include marking an executed mutation in the database with the LSN in order to preclude duplicate processing.

In example 4, the subject matter of any of examples 1-3 can optionally include periodically flushing content of the request log to an object storage service.

In example 5, the subject matter of any of examples 1-4 can optionally include wherein the receiving the mutation request, writing, executing, and generating are performed by one or more nodes of a plurality of nodes.

In example 6, the subject matter of any of examples 1-5 can optionally include wherein each node of the plurality of nodes writes their node identifier in the request log; and a listening thread on each node will only process entries which have their node identifier.

In example 7, the subject matter of any of examples 1-6 can optionally include wherein the request log and response log are divided into multiple request logs and multiple response logs, each of the divided request logs and divided response logs corresponding to a shard; and each node of the plurality of nodes is associated with one or more shards.

In example 8, the subject matter of any of examples 1-7 can optionally include dynamically reassigning shards among the plurality of nodes in response to change in workload or resource availability.

In example 9, the subject matter of any of examples 1-8 can optionally include wherein the receiving, by a watch server, change events comprises consuming the change events from a Kafka topic.

In example 10, the subject matter of any of examples 1-9 can optionally include wherein the receiving, by a watch server, change events comprises consuming the change events from the response log.

In example 11, the subject matter of any of examples 1-10 can optionally include receiving a watch API call from the watch client to subscribe to receiving the change notification, the watch API call including the filtering criteria and notification preferences.

Example 12 is a system for providing a database-agnostic watch service using a write-ahead log (WAL)-based architecture. The system comprises one or more processors and a memory storing instructions that, when executed by the one or more processors, cause the one or more processors to perform operations comprising receiving a mutation request from a client, the mutation request comprising a request to change, update, or delete an object in a database; writing the mutation request to a request log prior to executing the mutation request; executing the mutation request on the database; responsive to executing the mutation, generating a response message that includes the mutation request and an execution status; appending the response message to a response log; based on the response log, receiving, by a watch server, change events; and generating and transmitting a change notification to a watch client based on filtering criteria of the watch client applied to the change events.

In example 13, the subject matter of example 12 can optionally include wherein the operations further comprise in response to writing the mutation request to the request log, receiving a callback with a log sequence number (LSN) from the request log, the LSN corresponding to an entry in the request log associated with the mutation request.

In example 14, the subject matter of any of examples 12-13 can optionally include wherein the operations further comprise periodically flushing content of the request log to an object storage service.

In example 15, the subject matter of any of examples 12-14 can optionally include wherein the receiving the mutation request, writing, executing, and generating are performed by one or more nodes of a plurality of nodes.

In example 16, the subject matter of any of examples 12-15 can optionally include wherein the request log and response log are divided into multiple request logs and multiple response logs, each of the divided request logs and divided response logs corresponding to a shard; and each node of the plurality of nodes is associated with one or more shards.

In example 17, the subject matter of any of examples 12-16 can optionally include wherein the receiving, by a watch server, change events comprises consuming the change events from a Kafka topic.

In example 18, the subject matter of any of examples 12-17 can optionally include wherein the receiving, by a watch server, change events comprises consuming the change events from the response log.

In example 19, the subject matter of any of examples 12-18 can optionally include wherein the operations further comprise receiving a watch API call from the watch client to subscribe to receiving the change notification, the watch API call including the filtering criteria and notification preferences.

Example 20 is a machine-storage medium comprising instructions which, when executed by one or more processors of a machine, cause the machine to perform operations for providing a database-agnostic watch service using a write-ahead log (WAL)-based architecture. The operations comprise receiving a mutation request from a client, the mutation request comprising a request to change, update, or delete an object in a database; writing the mutation request to a request log prior to executing the mutation request; executing the mutation request on the database; responsive to executing the mutation, generating a response message that includes the mutation request and an execution status; appending the response message to a response log; based on the response log, detecting, by a watch server, change events; and generating and transmitting a change notification to a watch client based on filtering criteria of the watch client applied to the change events.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific examples, various modifications and changes may be made to these examples without departing from the broader scope of examples of the present invention. For instance, various examples or features thereof may be mixed and matched or made optional by a person of ordinary skill in the art. Such examples of the present subject matter may be referred to herein, individually or collectively, by the term “invention” merely for convenience and without intending to voluntarily limit the scope of this application to any single invention or present concept if more than one is, in fact, disclosed.

The examples illustrated herein are believed to be described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various examples of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of examples of the present invention as represented by the appended claims. The specification and drawings are, accordingly, to be regarded in an illustrative rather than a restrictive sense.

1. A method for providing a database-agnostic watch service using a write-ahead log (WAL)-based architecture, the method comprising:
receiving, by a metadata service platform, a mutation request from a client, the mutation request comprising a request to change, update, or delete an object in a database;
writing, by the metadata service platform, the mutation request to a request log prior to executing the mutation request;
executing, by the metadata service platform, the mutation request on the database;
responsive to executing the mutation, generating, by the metadata service platform, a response message that includes the mutation request and an execution status;
appending the response message to a response log that stores response messages generated after execution of mutation requests;
based on the response log, receiving, by a watch server, change events from entries in the response log; and
generating and transmitting a change notification to a watch client based on filtering criteria of the watch client applied to the change events.

2. The method of claim 1, further comprising:
in response to writing the mutation request to the request log, receiving a callback with a log sequence number (LSN) from the request log, the LSN corresponding to an entry in the request log associated with the mutation request.

3. The method of claim 2, further comprising:
marking an executed mutation in the database with the LSN in order to preclude duplicate processing.

4. The method of claim 1, further comprising:
periodically flushing content of the request log to an object storage service.

5. The method of claim 1, wherein the receiving the mutation request, writing, executing, and generating are performed by one or more nodes of a plurality of nodes.

6. The method of claim 5, wherein:
each node of the plurality of nodes writes their node identifier in the request log; and
a listening thread on each node will only process entries which have their node identifier.

7. The method of claim 5, wherein:
the request log and response log are divided into multiple request logs and multiple response logs, each of the divided request logs and divided response logs corresponding to a shard; and
each node of the plurality of nodes is associated with one or more shards.

8. The method of claim 7, further comprising:
dynamically reassigning shards among the plurality of nodes in response to change in workload or resource availability.

9. The method of claim 1, wherein the receiving, by a watch server, change events comprises consuming the change events from a Kafka topic.

10. The method of claim 1, wherein the receiving, by a watch server, change events comprises consuming the change events from the response log.

11. The method of claim 1, further comprising:
receiving a watch API call from the watch client to subscribe to receiving the change notification, the watch API call including the filtering criteria and notification preferences.

12. A system for providing a database-agnostic watch service using a write-ahead log (WAL)-based architecture, the system comprising:
one or more hardware processors; and
a memory storing instructions that, when executed by the one or more hardware processors, cause the one or more hardware processors to perform operations comprising:
receiving a mutation request from a client, the mutation request comprising a request to change, update, or delete an object in a database;
writing the mutation request to a request log prior to executing the mutation request;
executing the mutation request on the database;
responsive to executing the mutation, generating a response message that includes the mutation request and an execution status;
appending the response message to a response log that stores response messages generated after execution of mutation requests;
based on the response log, receiving, by a watch server, change events from entries in the response log; and
generating and transmitting a change notification to a watch client based on filtering criteria of the watch client applied to the change events.

13. The system of claim 12, wherein the operations further comprise:
in response to writing the mutation request to the request log, receiving a callback with a log sequence number (LSN) from the request log, the LSN corresponding to an entry in the request log associated with the mutation request.

14. The system of claim 12, wherein the operations further comprise:
periodically flushing content of the request log to an object storage service.

15. The system of claim 12, wherein the receiving the mutation request, writing, executing, and generating are performed by one or more nodes of a plurality of nodes.

16. The system of claim 15, wherein:
the request log and response log are divided into multiple request logs and multiple response logs, each of the divided request logs and divided response logs corresponding to a shard; and
each node of the plurality of nodes is associated with one or more shards.

17. The system of claim 12, wherein the receiving, by a watch server, change events comprises consuming the change events from a Kafka topic.

18. The system of claim 12, wherein the receiving, by a watch server, change events comprises consuming the change events from the response log.

19. The system of claim 12, wherein the operations further comprise:
receiving a watch API call from the watch client to subscribe to receiving the change notification, the watch API call including the filtering criteria and notification preferences.

20. A machine-storage medium comprising instructions which, when executed by one or more processors of a machine, cause the machine to perform operations for providing a database-agnostic watch service using a write-ahead log (WAL)-based architecture, the operations comprising,
receiving a mutation request from a client, the mutation request comprising a request to change, update, or delete an object in a database;
writing the mutation request to a request log prior to executing the mutation request;
executing the mutation request on the database;
responsive to executing the mutation, generating a response message that includes the mutation request and an execution status;
appending the response message to a response log that stores response messages generated after execution of mutation requests;
based on the response log, receiving, by a watch server, change events from entries in the response log; and
generating and transmitting a change notification to a watch client based on filtering criteria of the watch client applied to the change events.
